(19) United States
(12) Patent Application Publication
(10) Pub. No.: US 2015/0350541 A1
(43) Pub. Date: Dec. 3, 2015

(54) Solar Powered Video Security Device

(71) Applicant: Angus Richards, Barellan Point (AU)

(72) Inventor: Angus Richards, Barellan Point (AU)

(21) Appl. No.: 14/727,671

(22) Filed: Jun. 1, 2015

Related U.S. Application Data
(60) Provisional application No. 62/006,287, filed on Jun. 2, 2014.

(51) Int. Cl. H04N 5/232; H04N 5/225

(52) U.S. Cl. CPC H04N 5/23238; H04N 5/23241; H04N 5/2256; H04N 5/2252

(57) ABSTRACT

The invention describes the design of a solar powered wireless panoramic IP security camera for outdoor applications that requires no external electrical power or data cabling and features a unique solution to the inherent false triggering issues associated with conventional image-based motion tracking, through the use of a novel optical arrangement.

### CROSS REFERENCE TO RELATED APPLICATIONS

This application claims priority of U.S. provisional patent application No. 62/006,287 titled “Solar Powered Video Security Device” filed Jun. 2, 2014 by Angus Richards.

### DEFINED TERMS

For the purposes of this specification, the subsequent acronyms are defined as follows:

CCTV (Closed Circuit Television)

IP (Internet Protocol)

LED (Light Emitting Diode)

PSU (Power Supply Unit)

PV (Photovoltaic)

### BACKGROUND OF INVENTION

The IP security camera represents a great step forward in the field of video-based security. It offers great advantages over its CCTV predecessor. In particular its inherent ability to be monitored remotely via internet protocol wired and wireless networks, utilising a diverse range of platform independent software. Additionally, its ability to stream real-time video imagery to mobile devices such as smart phones has changed the paradigm of the security industry from one of service provider based monitored security to one of user monitored security.

The development of low-cost “system in chip” integrated circuits in collaboration with affordable high-performance imaging chips have realised low-cost high-performance digital imaging solutions for security IP cameras. Additionally, recent developments in Wi-Fi technology provide robust high-performance digital wireless networks with gigabit speeds. The combination of these technologies has realised a rapid influx of new designs. Wi-Fi capable IP security cameras are now the technology solution of choice for video security. These systems are both high-performance and inexpensive offering previously unheard of levels of image resolution and functional features. In particular, video-based motion tracking and area denial are exciting new features available as standard with most current high-end IP security cameras.

Although potentially offering high-performance features, motion tracking is largely ineffective in any but highly controlled artificially lit environments. Even indoor situations with artificial lighting are prone to false triggering if windows or skylights are present in the room. Additionally, the movement of other objects in the room often causes false triggering due to changes in reflectivity of ambient light (for example the movement of curtains due to air-conditioning). In outdoor environments, the great variability of light levels and spectral distribution in addition to complex movement of objects such as leaves on trees renders most image-based motion tracking systems inoperative or ineffective.

Other motion detection systems such as passive infrared are equally ineffective in outdoor environments. The reasons for this are similar to the failings of video-based motion detection because even though the detection spectrum utilised is vastly different in frequency, it is still affected by variable occlusion and movement of objects such as leaves in exactly the same way as visible spectrum systems. Additionally, sunlight itself contains a significant amount of radiant energy in the long wave infrared spectra therefore the movement of shadows across surfaces is a significant source of false triggering in passive infrared systems. In addition to reflected radiant energy, passive infrared systems are also very sensitive to movement of air with a temperature differential. A typical example of this occurs when a light breeze blows over the surface of warm asphalt or concrete, and is liable to cause false triggering for many hours even after sunset.

Quite clearly, for a motion triggered alarm system to be of any use whatsoever, false triggers must be very infrequent. One simple technique that has existed for a long time but is effective in an outdoor environment is a point-to-point light beam interrupter. The system can utilise LED light sources or laser-based light sources and may consist of either a transmitter receiver pair or a single transmitter/receiver with a reflective surface at the other end. Typically, infrared or near infrared spectrum devices are used to reduce the visibility of the system to the human eye.

Although extremely effective for indoor environments with controlled lighting, the current generation of IP security camera solutions fail to operate effectively in outdoor environments. Additionally, the requirement of electrical supply for these cameras often negates all of the cost advantages achieved through mass production. Having to supply waterproof housings and professionally installed cabling to provide electrical supply requires professionally licensed installers. Typically, the installation of even a very simple outdoor IP security camera system will cost many tens of thousands of dollars even though the cameras utilised within these systems are relatively inexpensive. The strict regulations imposed on electrical installations generally preclude user installation of such systems, forcing end-users to employ electricians to install the electrical wiring. For the same reasons, even many large security companies will not install electrical wiring and quite often subcontract electricians to perform this task.

### SUMMARY OF INVENTION

The objective of this invention is to produce a full function wireless panoramic IP security camera for outdoor use in an entirely user installable configuration. The device will be solar powered, thus overcoming the requirement for any external electrical power and associated cabling. Additionally, the invention seeks to overcome the inherent false triggering issues associated with image-based motion tracking through the use of a novel optical arrangement in conjunction with conventional image based tracking technology.

### BRIEF DESCRIPTION OF THE DRAWINGS

FIG. 01 is a perspective view of a preferred embodiment of the overall system and indicates the major components and their relative orientation and size in relation to an adult man, according to the present invention.

FIG. 02 is an exploded view of a preferred embodiment, indicating the major electrical components involved in the system, according to the present invention.

FIG. 03 is a perspective view showing a typical application of the system in a domestic environment and, in particular, highlighting the functionality of a “single wall” configuration of the “photon fence” optical motion detection system, according to the present invention.

FIG. 04 is a perspective view showing a typical application of the system in an outdoor environment, featuring several systems working together and, in particular, highlighting the functionality of an alternate embodiment of the “photon fence” optical motion detection system operating in an “area denial” mode, according to the present invention.

FIG. 05 is a fragmentary sectional view showing the functional blocks involved in the creation of one preferred embodiment of the “photon fence” optical motion detection system, according to the present invention.

FIG. 06 is a fragmentary sectional view showing the functional blocks involved in the creation of an alternate preferred embodiment of the “photon fence” optical motion detection system, according to the present invention.

FIG. 07 is a fragmentary sectional view showing the functional blocks involved in the creation of an alternate preferred embodiment of the “photon fence” optical motion detection system, according to the present invention.

FIG. 08 is a perspective view of the overall system, highlighting one preferred embodiment of a semipermanent base mounting system, according to the present invention.

FIG. 09 is a perspective view of the overall system, highlighting an alternate preferred embodiment of a permanent base mounting system, according to the present invention.

FIG. 10 is a perspective view of the overall system, highlighting an alternate preferred embodiment of a temporary base mounting system, according to the present invention.

FIG. 11 is a perspective view of the overall system, highlighting an alternate preferred embodiment of a permanent base mounting system, according to the present invention.

### DETAILED DESCRIPTION OF THE PREFERRED EMBODIMENTS

The most bulky component in the system is the solar panel. Consequently, the overall design of the system has been built around the solar panel. Although, obviously a large rectangular solar panel could be utilised in the system, the purpose of this project was to produce a compact, aesthetically pleasing commercial product. Ideally the solar panel should be circular. However, this would require the use of segment shaped solar cells which are not readily available. An acceptable compromise was the use of a square PV array. The initial PV panel design was based around a minimum voltage configuration capable of charging a single lithium polymer battery cell. A configuration of nine mono crystalline silicon solar cells was used in the initial design in order to minimise the number of cell interconnects and simplify the overall electronics. Back connect silicon solar cells were used to optimise the effective area ratio of the panel. At the time of the prototype development, the highest efficiency solar cells that were readily available were in the order of 22% efficient (produced by SunPower Corp.) Much higher efficiency non-concentrator cells were already in existence but were not readily available for commercial projects. When more efficient solar cells become available and commercially viable, the possibility exists to scale down the size of the PV array and consequently the entire IP camera device.

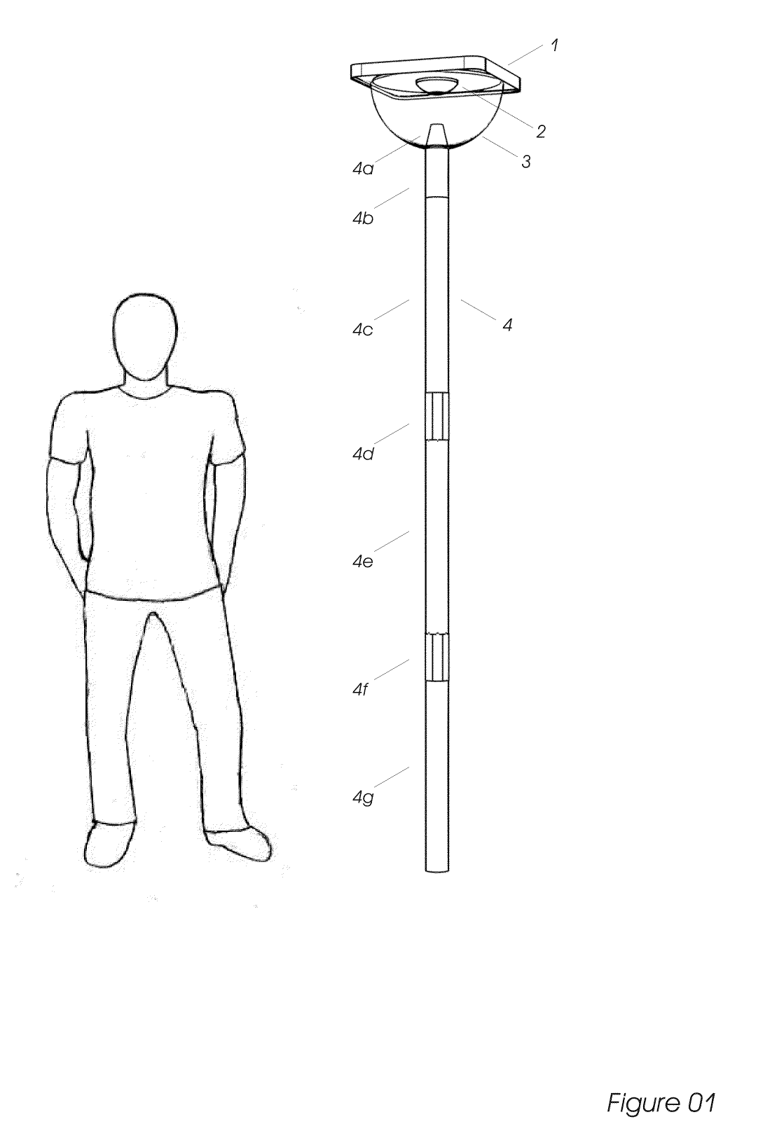

As can be seen in FIG. 1, PV panel (1) and panoramic camera (2) are supported atop mast (4) by virtue of transparent plastic dome (3). In this way, the panoramic camera will have an unobstructed 360 degree field of view horizontally and nearly a 90 degree field of view vertically, with only a small circle (approximately 1 m in diameter) being occluded by the supporting mast.

In a preferred embodiment shown in FIG. 1, the mast (4) may be comprised of tubular sections (4c, 4e, 4g) and joiners (4d, 4f), in addition to cap sections 4a, 4b which are used to couple the transparent dome (3) to the mast assembly (4).

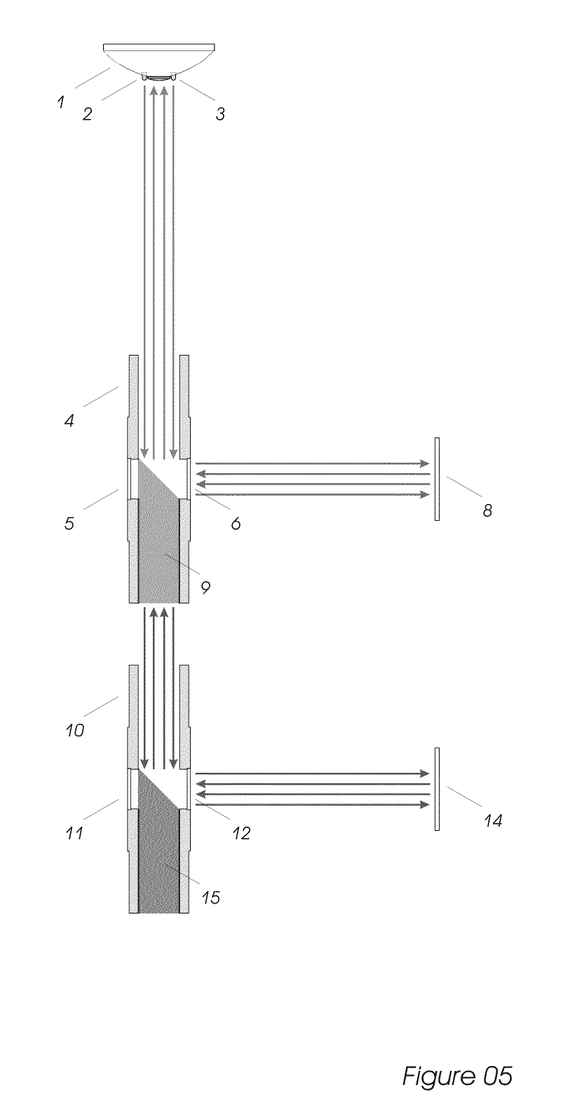

The joiners (4d, 4f) shown in FIG. 1 may contain additional optics and comprise part of the optional “photon fence” optical motion detection system as shown in more detail as part numbers 4, 10 in FIGS. 5-7.

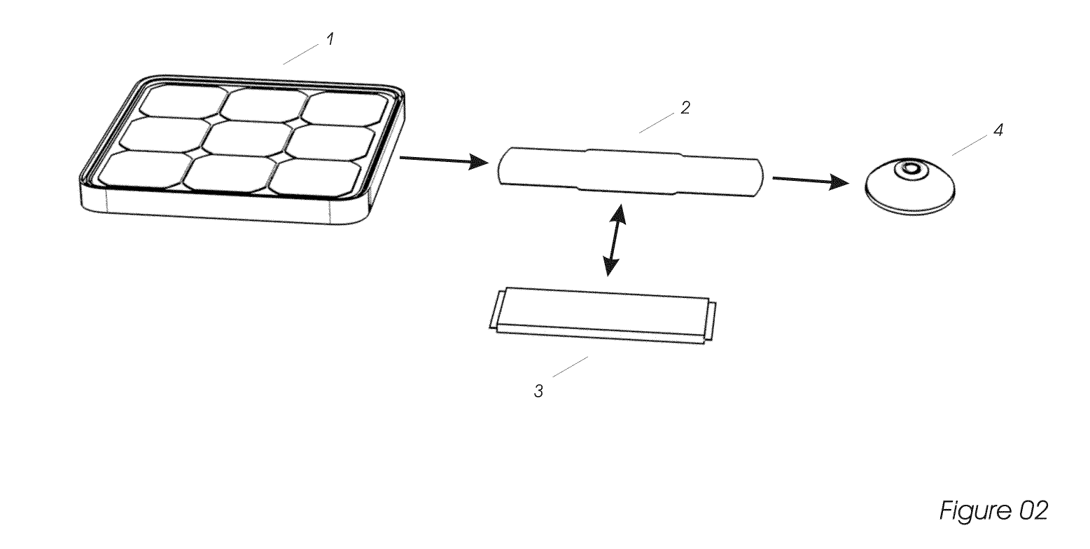

As shown in FIG. 2, the panoramic camera (4) utilises power from a power supply unit (2). This power supply unit derives electricity from the PV panel (1) via the internal storage battery (3). In the prototype device, the storage battery utilised lithium polymer battery technology. However, other energy storage technologies may be utilised including the possibility of Super Capacitors as an alternative to chemical energy storage systems.

Because the present invention uses wireless technologies (Wi-Fi, 3G/4G etc.) to communicate with an external network or playback device, there is no requirement for any wiring between the IP camera system and the outside world, thereby eliminating any points of visual occlusion which are present with other conventional dome based camera topologies such as wall and pole mounts.

The IP camera used in the prototype system is of the hemispherical fisheye design. This camera design couples a 180 degree field of view fisheye lens with a high resolution image sensor to capture a full hemispherical field of view. The field of view extends 90 degrees from the horizon down to the vertical and horizontally in a full 360 degrees. This camera topology is particularly efficient in this design because the solar panel visually occludes any view above the horizon anyway. Because the transparent dome has no visual occlusion zones, the only obscuring component in the design is the support mast itself. This project utilises the small occluded area of view, which is shadowed by the mast, as a special zone for a point to point light beam interrupter. The light beam interrupter will utilise the on-board visual motion detection software provided in the IP camera. However, through the use of specialised optics the undesirable characteristics of visual motion detection can be overcome.

The hollow tubular mast, combined with refractive and reflective optics, generates and projects a collimated beam of light (originating from a series of LEDs or laser diodes surrounding the lens of the panoramic camera) outwards from the axis of the mast to a retro-reflective surface. The retro-reflective surface returns this light beam along substantially the same optical path back to the lens of the IP camera. The IP camera will perceive this returned light as a bright circle in the centre of the field of view. By configuring the motion detection region to coincide with this location a very strong and stable optical signal can be achieved.

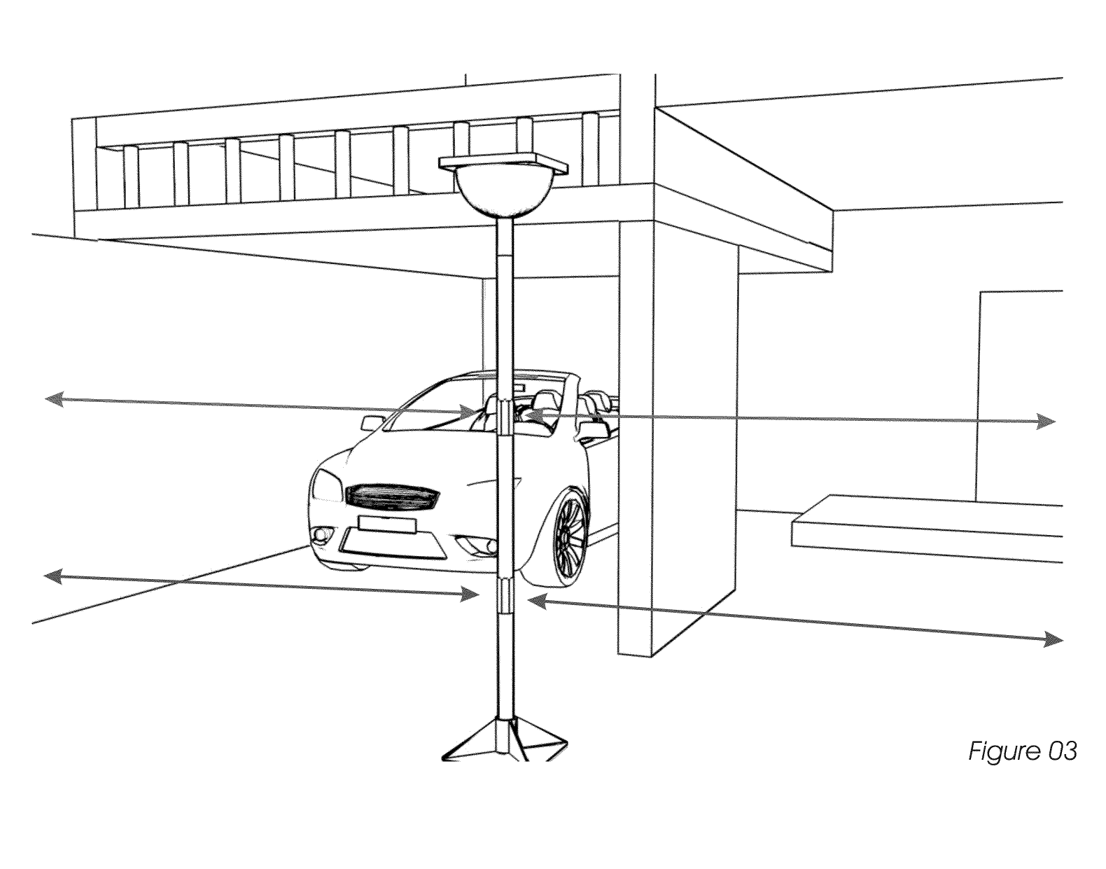

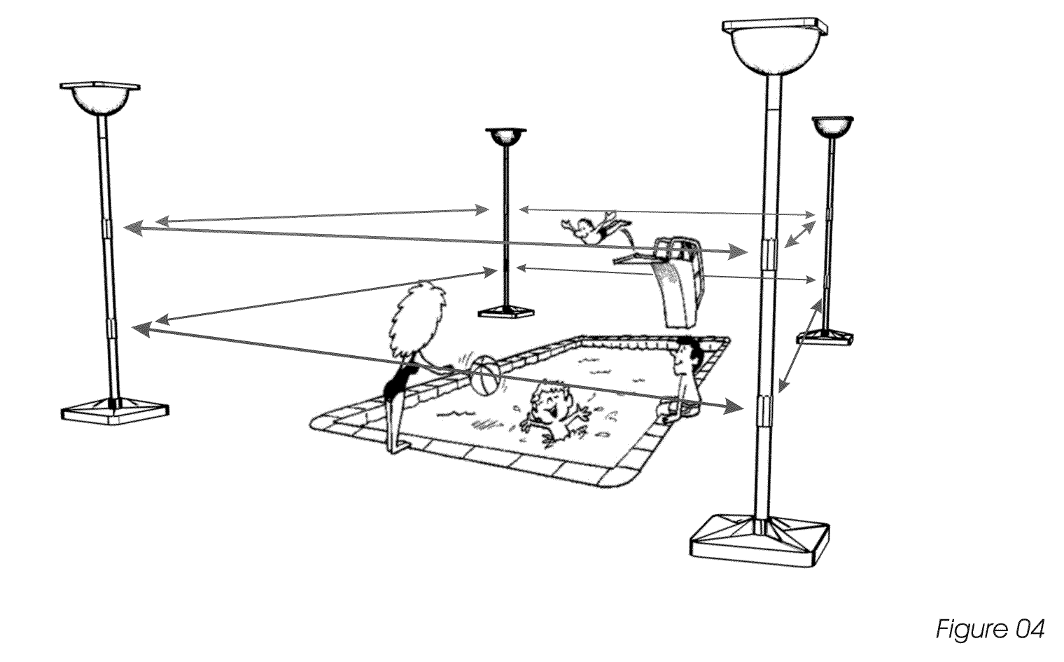

Unlike the internal motion detection system utilising ambient light, the reflected light will be very bright and independent of variable ambient conditions. By utilising one or more reflective elements incorporated into one or more of the mast joiners it becomes possible to redirect this light beam perpendicular to the mast and adjustable in a 360 degree arc. The retro-reflective surface can be mounted on any vertical surface such as a wall or simply mounted on the back of another similar camera mast. By incorporating a series of camera masts spaced at regular intervals, it is possible to create a continuous “photon fence” that can protect a boundary or region. Typical configurations are shown in FIGS. 3, 4.

The “photon fence” can be achieved utilising several different techniques, all of which rely on forming a substantially collimated beam of light which travels inside and substantially co-axial with the mast. However, the different techniques each have different advantages and limitations associated with them.

The most obvious technique involves the use of a relay lens configuration, similar to the design of a periscope, in conjunction with a ring of LED light sources placed close to but peripheral the optical axis of the panoramic camera lens and facing slightly inwards thereby generating a “virtual emitter” which is on-axis with the panoramic camera. Although this technique would work when utilising conventional rectilinear design camera lenses, the panoramic camera system will have to utilise a fisheye style lens. These lenses process light rays in a different way to conventional rectilinear design camera lenses and tend to block light rays whose angle of incidence is not convergent on the virtual focal point of the lens. Because the retro-reflective surface will return the outgoing light rays back along substantially the same optical paths, the rays will tend to be incident upon only the edge of the camera lens. At this point they will be striking the lens at nearly 90 degrees from the normal entry angle for light rays of the camera lens. Consequently they will be mostly blocked by the aperture in the lens and not perceived by the camera to any significant level. Even if these problems could be overcome, the emitted beam is not perfectly collimated and thus subject to magnification effects which will cause the emitted beam to expand significantly upon exiting the mast. This is non-ideal because the returned light will only comprise a proportion of the light which actually strikes the reflective surface, thus any beam expansion directly reduces the brightness of the returned beam.

FIGS. 5-7 illustrate preferred embodiments, which address some of the most significant of these limitations by simply utilizing one or more semi collimated light sources facing directly downwards through the inside of the hollow mast assembly and incident upon one or more reflective elements incorporated into one or more of the mast joiners to redirect the partially collimated light beam/beams outwards, essentially perpendicular to the mast axis. In this design, the collimating lens/lenses (5-6, 11-12) are placed as far from the LED light sources (2, 3) as possible in order to reduce the magnification effect.

The partially collimated light beams could be based on LED or laser diode light sources (2, 3) with simple single element collimating lenses located close to the emitters. In the case of LED based emitters, this is often part of the plastic moulding of the LED component itself. Although not perfectly collimated, LEDs can typically achieve a 10 degree spread of emitted light which is probably sufficient to maintain an acceptable level of optical efficiency. The emitted light is first redirected by substantially 90 degrees by reflection off the surface of reflective elements (9, 15) which are typically located within the mast joiners (4,10), and then incident on long focal length collimating lens elements (5-6, 11-12). The collimating lens elements aid in controlling the divergence of emitted light beam. Given that the distance between the light emitter and the collimating lens is at least 1 meter, the overall magnification is expected to be in the order of 10:1 which will probably not result in significant problems due to beam expansion related optical losses.

Ideally, the collimating lens elements (5-6, 11-12) would have focal lengths equal to the optical path length between themselves and the optical emitters (2, 3) which would be in the order of 1 meter for lens elements (5-6) and about 2 meters for elements (11-12).

An alternative approach which both reduces the system complexity and further improves beam collimation and subsequent optical efficiency is to utilise laser diodes instead of LED light sources. Although Laser diodes are significantly more expensive than LED light sources, they possess several properties which can be utilised to improve system performance. Firstly, because the optical emitting element is extremely small and the device emits almost perfectly monochromatic light, it is possible to produce almost perfectly collimated light beams, utilising inexpensive single element optics.

Because the light beams emitted from the laser modules are already highly collimated, the collimating lens elements (5-6, 11-12) shown in FIGS. 5-7, can be replaced by simple flat optical windows thereby reducing production costs and offsetting the added costs of the laser diode modules. Additionally, the emitted light beams are almost perfectly collimated and thus the majority of the emitted light will be returned by the retro-reflector elements (7-8, 13-14) to the optical system and ultimately, the panoramic camera (1).

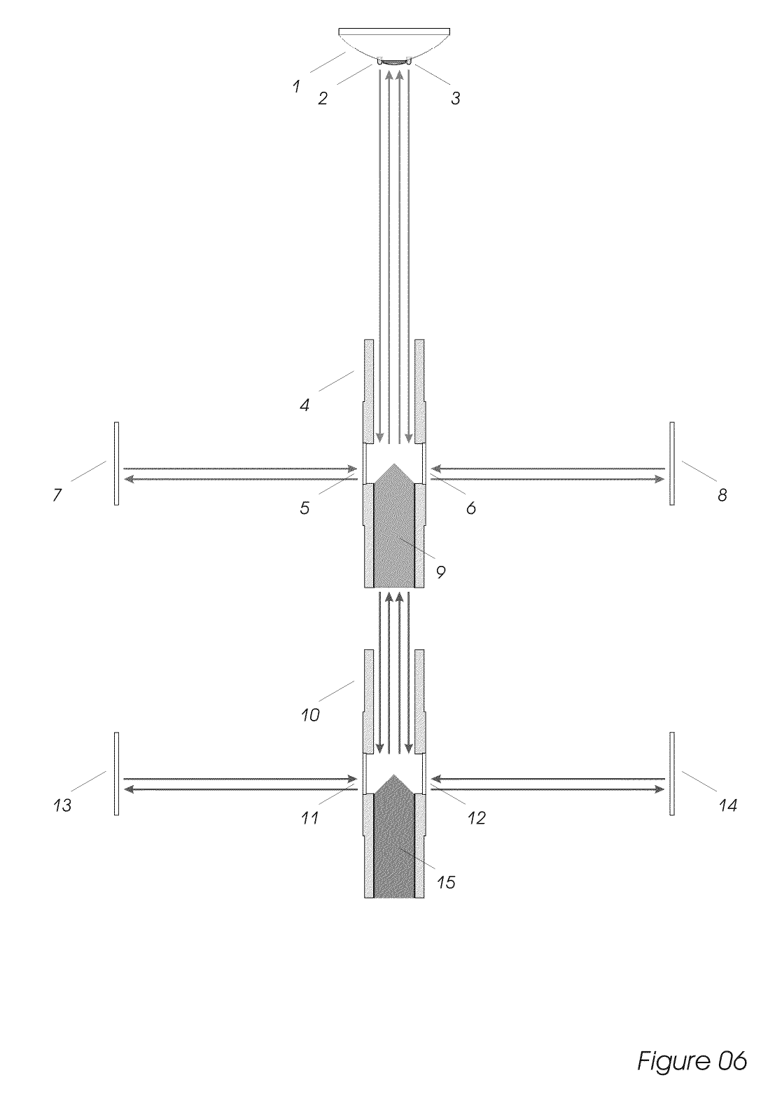

In addition to redirecting a single beam, the reflective elements (9, 15) located within the mast joiners (4, 10) could be designed with multiple surfaces or even a continuous conical reflective surface to produce multiple beams or even a flat disk of light respectively. A typical design of single and dual beam reflectors are shown in FIGS. 5, 6 respectively.

An important factor to consider however is that the point-to-point light beam system is only effective in eliminating false triggering because the returned beam is significantly more intense than ambient reflections, the addition of multiple beams, and in particular a disk of light will reduce the sensitivity of the system greatly and will probably negate the effectiveness of the approach. A practical system is probably limited to using only several beams at most (without utilising additional techniques to independently analyse beams separately).

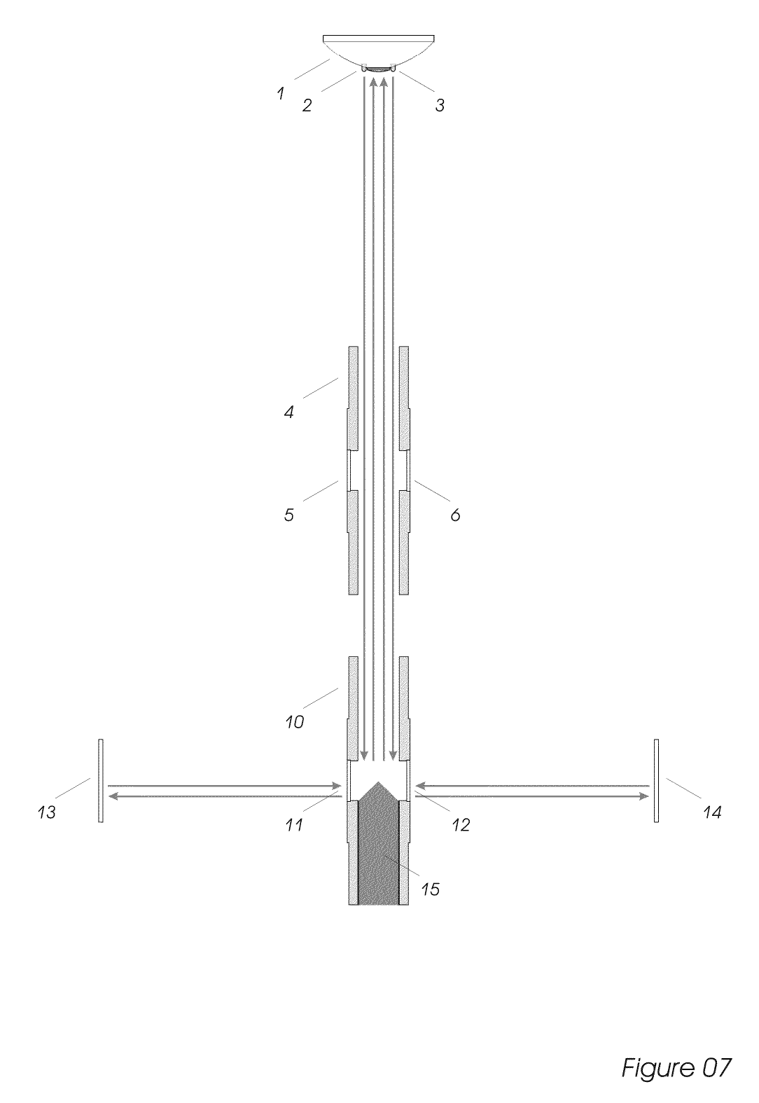

In addition to multiple horizontal beams being emitted from just one mast joiner (4 or 10) as shown in FIG. 7, it Is also possible to emit beams from both the upper and lower mast joiners (4, 10) simultaneously, by utilising either a partially reflective element (9) (mirror/prism etc.) or preferably though the use of a wavelength selective reflective element (9) (dichroic mirror/prism) as shown in FIGS. 5, 6. Additionally, a reflective element (9) which selectively reflects and transmits light according to angle of polarization could equally well be used. Both dichroic and polarizing reflective elements will be significantly more optically efficient than the use of partially reflective mirrors/prisms.

The main disadvantage to using these exotic reflective surfaces is one of cost, as they are both significantly more expensive than plain mirrors or simple prisms. Dichroic reflective elements are probably less difficult to work with than polarizing reflective elements because many reflective and refractive elements alter the angle of polarisation of the incident light.

The requirement of co-axial alignment of the optical emitters (2, 3) with upper and lower reflective elements (9, 15) can be easily solved through the use of multi spectral emitters such as white LEDs. In this case, just one or two LEDs would be required to provide the light source for both upper and lower beam emitters and would be subsequently separated into different light frequencies by virtue of the dichroic beam splitter (9) (reflector) as shown in FIGS. 5, 6. Of course a similar situation could also be achieved through the use of a pair of LED or laser emitters of different frequency (colour of emitted light) placed parallel and closely spaced. However, the ability of a simple white light LED to achieve perfect co-linearity is an added advantage.

An advantage of introducing a direct correlation between the light source and the emitted beam (rather than average of several beams) is that it becomes possible to isolate and analyse the beams separately through selectively switching the optical emitters (2, 3) on and off on a frame by frame basis, as controlled by the camera system. These same techniques can also be used to reduce the effects of ambient lighting through differential image processing.

The separation of the returned beams through colour is also possible if a colour panoramic camera system is used, and will work with all of the afore mentioned optical systems.

The choice of number of emitted beams and beam configuration can be selected by choosing the appropriate reflector element/elements (9, 15) and could be designed to be user configurable even with a fixed number of beam emitters (2, 3). For example, the configurations shown in FIGS. 5-7 could produce 1-4 beams from just 2 white light LED emitters (2, 3) depending on the choice of reflective elements (9, 15).

In addition to producing more emitted beams, more complex “photon fence” beam patterns can be readily achieved simply by reflecting the beams off plain mirrors before they finally strike the retro-reflector elements (7-8, 13-14). In this way, complex and denser beam patterns can easily be realized using only a small number of these security systems.

Because of the greater degree of beam collimation and higher intensity, it is anticipated that laser based systems will be capable of significantly longer “photon fence” distances than LED based systems.

The initial prototype system utilised a visible light IP camera and thus incorporated visible light sources as part of the “photon fence” point to point light beam system. However, if alternate cameras with near infrared capability were utilised, infrared light sources may equally well be utilised.

The “photon fence” feature of this project is considered to be optional and may or may not be included as part of the base model. The inclusion or exclusion of this feature does not diminish the generality of the claims in this specification.

Several alternate options are proposed for mounting the mast assembly (4) to a solid surface. These options range from weighted bases for temporary installations (for situations where theft and/or interference by personnel is not an issue) to semipermanent options, incorporating stakes that can be driven into the ground and permanent installations which incorporate brackets or flanges to clamp or bolt the mast assembly to a rigid surface or structure.

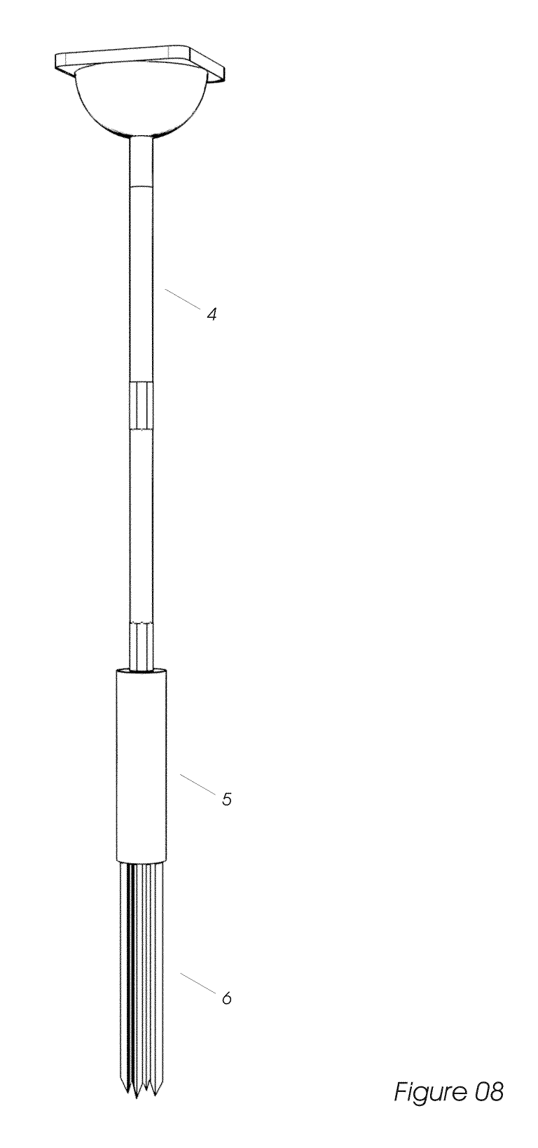

The current preferred embodiments of these mounting options as illustrated in FIGS. 08-11

The preferred embodiment illustrated in FIG. 08 describes a semipermanent mounting option based on “star pickets” (6) which are a common three sided metal stake that can be driven into the ground by a sledge hammer or equivalent tool. Four such “star pickets” (6) driven into the ground can form a strong mounting support for the mast assembly (4) which would then be slid inside of the array of protruding stakes and secured tightly in place by virtue of two or more adjustable metal bands such as muffler clamps (commonly used in the automotive industry). A plastic outer collar (5) could then be slid over the top of the mounting assembly and filled up with sand, stones or concrete (depending on the level of security required) and would provide a tamper free and aesthetically pleasing result.

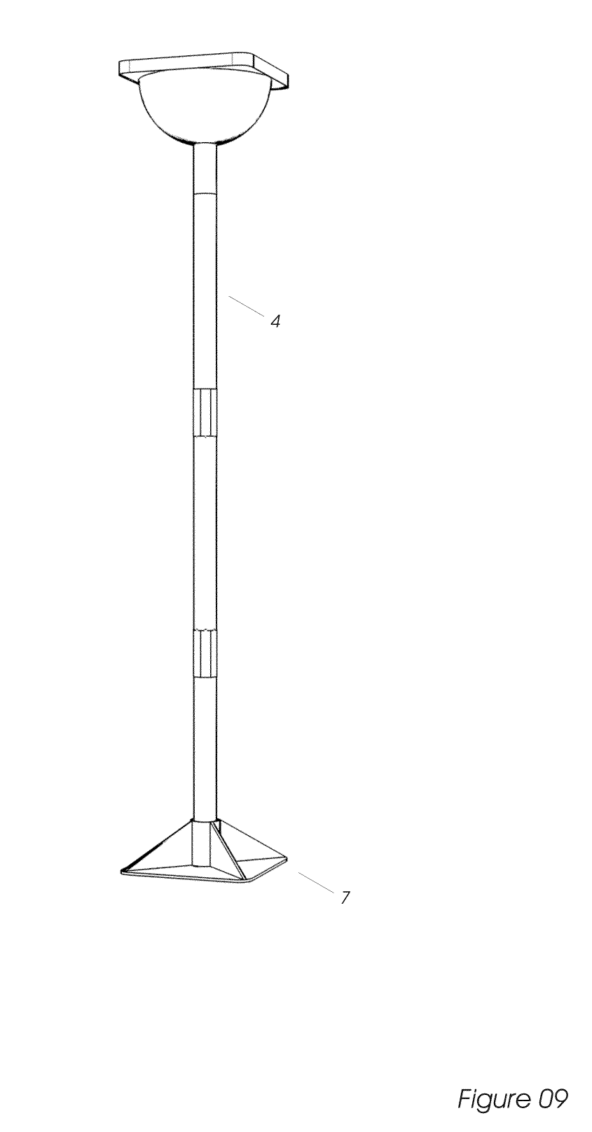

FIG. 09 illustrates a preferred embodiment which is appropriate for permanent mounting of the system to a flat horizontal surface capable of accepting bolts or heavy duty screws and involves the use of a flat flange base (1) for securing the mast assembly (4) to said surface.

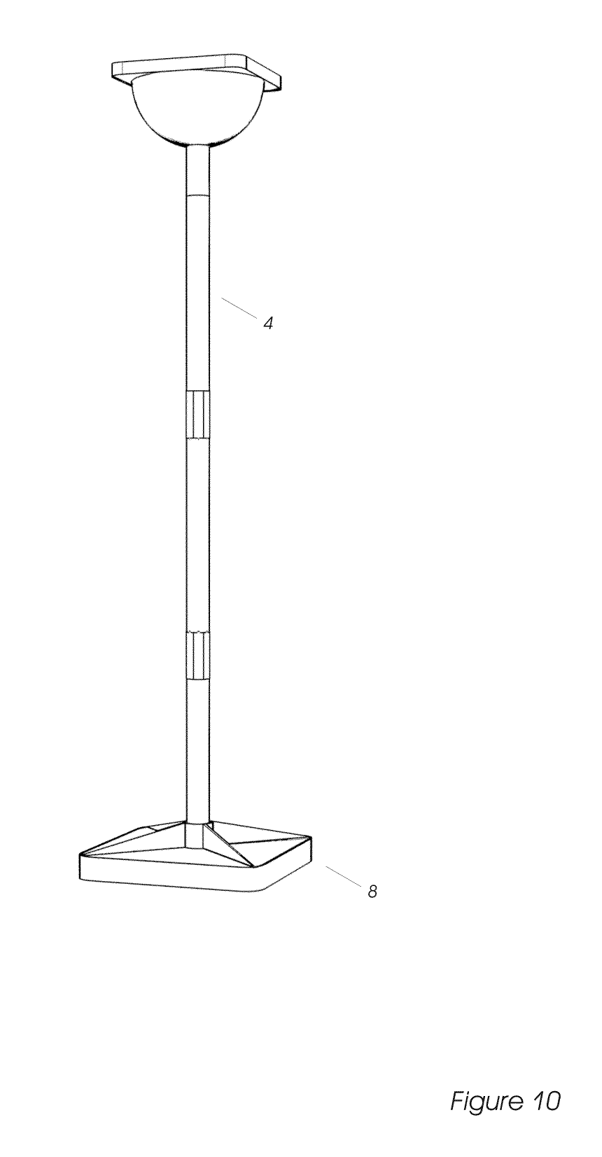

FIG. 10 illustrates a preferred embodiment which is appropriate for temporary mounting of the system on a relatively flat horizontal surface and simply features a moulded metal or plastic base (8) that can be further weighted through the inclusion of sand, water or concrete. This embodiment is appropriate for short term installations or in situations which already offer a degree of protection from interference by personnel.

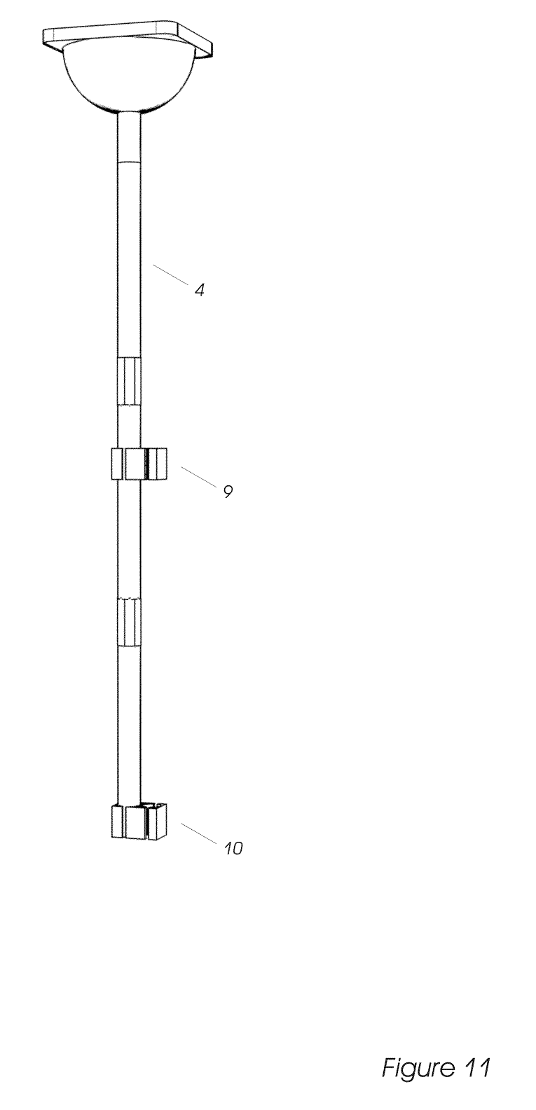

FIG. 11 illustrates a preferred embodiment which is appropriate for permanent mounting of the system to a flat vertical surface or existing tubular structure such as a wall or fence and features two or more clamp assemblies (9, 10) to secure the mast assembly (4) to said structure.

1) A solar powered IP camera for security and general monitoring applications which comprises the following components;
a) a PV panel for deriving electrical energy from sunlight
b) a device for storing electrical energy derived from said PV panel
c) a PSU device for controlling the movement of electrical energy to and from said storage device
d) a panoramic camera device for digitally capturing, processing, storing and outputting visual information and which may optionally also have the capability of capturing, processing, storing and outputting auditory information, and where said panoramic camera device is capable of capturing at least a full hemispheric field of view.
e) a wireless communication device for connection of said camera device to a digital data network
f) transparent dome shaped enclosure for providing environmental protection and physical support of camera device
g) a supporting mast

2) A device as specified in claim 1, in which the mast consists of a series of tubular sections connected together with joiners.

3) A device as specified in claim 2 in which at least one of the said joiners incorporates additional optical components which comprise one or more reflective elements such as mirrors, prisms, or holographic materials such that the reflective surfaces are angled at substantially 45 degrees to the axis of the mast and optionally one or more transparent optical windows or collimating lenses thereby allowing a light beam traveling inside and substantially coaxial to the mast axis to exit said mast approximately perpendicular to the mast axis.

4) A device as specified in claim 3 in which the reflective elements utilise surfaces which partially reflect and partially transmit incident light.

5) A device as specified in claim 3 in which the reflective elements utilise surfaces which selectively reflect or transmit incident light dependent upon colour (frequency) of said light.

6) A device as specified in claim 3 in which the reflective elements utilise surfaces which selectively reflect or transmit incident light dependent upon polarisation of said light.

7) A device as specified in claim 3 that produces a plurality of light beams extending approximately perpendicular to the axis of the mast.

8) A device as specified in claim 1 which incorporates one or more light sources surrounding the lens of the IP camera such that these light sources are directed downwards through the hollow mast sections and are incident upon the additional optical components specified in claim 3 whereby these optical components redirect said light beam/beams substantially perpendicular to the axis of the mast.

9) A device as specified in claim 8 in which the light sources are LED or laser modules that incorporate integrated optical elements and produce a beam of light that is at least partially collimated.

10) A device as specified in claim 3 which additionally incorporates one or more retro-reflective surfaces as a target material for the optical beam/beams exiting the mast joiner assembly/assemblies.

11) A device as specified in claim 1 which additionally comprises one or more long metal stakes, a means such as one or more metal bands for securing said metal stakes to the supporting mast, and a hollow protective collar, to facilitate semi-permanent mounting of the camera system in soft earth or sand.

12) A device as specified in claim 1 which additionally comprises a flat flange base to facilitate a permanent mounting to solid horizontal surfaces such as concrete.

13) A device as specified in claim 1 which additionally comprises a weighted base for temporary installations.

14) A device as specified in claim 1 which additionally comprises two or more tube clamp assemblies to facilitate a permanent mounting of the supporting mast to solid vertical surfaces or tubular structures.
